(19) United States
(12) Patent Application Publication
(10) Pub. No.: US 2007/0051552 A1
(43) Pub. Date: Mar. 8, 2007

(54) All terrain vehicle and integrated control panel for attachment to handlebar of all terrain vehicle

(76) Inventor: Camas Reed, Columbus, OH (US)

Correspondence Address: DINSMORE & SHOHL, LLP, 1900 CHEMED CENTER, 255 EAST FIFTH STREET, CINCINNATI, OH, 45202, US

(21) Appl. No.: 11/219,168

(22) Filed: Sep. 2, 2005

(51) Int. Cl. B60K 26/00

(52) U.S. Cl. 180/333; 180/336

(57) ABSTRACT

A control panel can be attached to a handlebar of an all terrain vehicle adjacent to a handgrip. The control panel includes a drive wheel selection actuator and at least one other control device other than a drive wheel selection actuator, such as an engine control or lamp control, for example. An engine control can include an engine start pushbutton and/or an engine stop switch, and a lamp control can be configured to selectively activate at least one of a running light, a headlight, and a turn signal. The drive wheel selection actuator can be connected with a drive system of an all terrain vehicle and can be configured to facilitate selective mechanical coupling of the drive system with the wheels of the all terrain vehicle. In some embodiments, the drive wheel selection actuator can selectively generate a two wheel drive command signal and a four wheel drive command signal.

### TECHNICAL FIELD

The present invention relates to a control panel which can be configured for attachment to a handlebar of an all terrain vehicle (hereinafter sometimes referred to as an “ATV”) and which can include a drive wheel selection actuator as well additional control actuators for the ATV.

### BACKGROUND OF THE INVENTION

Many ATVs are provided with selective four wheel drive capability. In order to enable the four wheel drive feature, an operator of the ATV must typically engage some electrical and/or mechanical actuator. Although such an actuator might be located on one or more wheel hubs of an ATV, the actuator might alternatively be provided in a location more conveniently accessible to an operator. For example, the actuator can comprise a switch or pushbutton that is located in a housing, and the housing can be attached to a handlebar of the ATV in a location adjacent to one of the handgrips in order that an operator may easily access the actuator during operation of the ATV. However, conventional disposition of a four wheel drive actuator upon the handlebars of an ATV, as shown for example in FIG. 4 and discussed further below, introduces excessive bulk onto the handlebars, requires excessive assembly time, is unsightly, and is relatively expensive. Accordingly, there is a need for a drive wheel selection actuator for an ATV which does not introduce excessive bulk to the handlebars of an ATV, can be easily installed during manufacturing of the ATV, is attractive, and is relatively inexpensive.

### SUMMARY OF THE INVENTION

In accordance with one embodiment of the present invention, an ATV is provided which comprises at least one front wheel, a plurality of rear wheels, a drive system, a handlebar assembly, and a control panel attached to the handlebar assembly. The control panel supports a plurality of control devices. One of the control devices comprises a drive wheel selection actuator that is connected with the drive system and is configured to facilitate selective mechanical coupling of the drive system with at least one of the wheels. At least one other of the control devices comprises a control device other than a drive wheel selection actuator.

In accordance with another embodiment of the present invention, an ATV comprises a left front wheel, a right front wheel, a left rear wheel, and a right rear wheel. The ATV further comprises a drive system configured for selective mechanical coupling with each of the left front wheel, the right front wheel, the left rear wheel, and the right rear wheel. The drive system is adapted to cause rotation of only at least one of the left rear wheel and the right rear wheel upon receipt of a two wheel drive command signal, and to cause rotation of at least one of the left front wheel and the right front wheel, and at least one of the left rear wheel and the right rear wheel, upon receipt of a four wheel drive command signal. The ATV additionally comprises a handlebar assembly and a control panel. The handlebar assembly includes a left handlebar and a right handlebar, wherein the left handlebar has a left handgrip and the right handlebar has a right handgrip. The control panel is attached to one of the left handlebar and the right handlebar adjacent to one of the left handgrip and the right handgrip. The control panel supports a drive wheel selection actuator, an engine control, and a lamp control. The drive wheel selection actuator is connected with the drive system and is configured to selectively generate the two wheel drive command signal and the four wheel drive command signal. The engine control comprises at least one of an engine start pushbutton and an engine stop switch. The lamp control is configured to selectively activate at least one of a running light, a headlight, and a turn signal.

In accordance with yet another embodiment of the present invention, a control panel is configured for attachment to a handlebar of an ATV adjacent to one of a left handgrip and a right handgrip. The control panel comprises a drive wheel selection actuator, an engine control, and a lamp control. The engine control comprises at least one of an engine start pushbutton and an engine stop switch. The lamp control is configured to selectively activate at least one of a running light, a headlight, and a turn signal.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is a rear perspective view of an ATV having a control panel in accordance with one embodiment of the present invention;

FIG. 2 is an enlarged rear perspective view depicting the portion of the ATV of FIG. 1 including the control panel;

FIG. 3 is an enlarged perspective view depicting a portion of an ATV in accordance with another embodiment of the present invention, wherein a control panel is connected with a right handlebar; and

FIG. 4 is a rear perspective view depicting a conventional handlebar assembly for an ATV.

### DETAILED DESCRIPTION

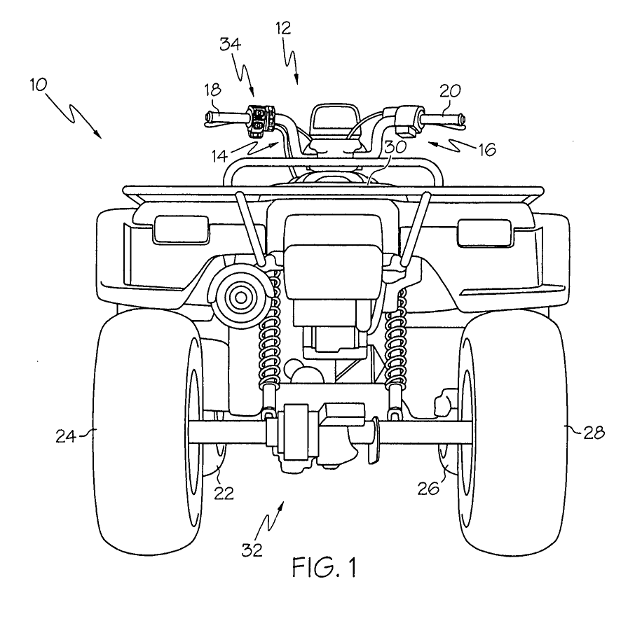

The present invention and its operation are hereinafter described in detail in connection with the views and examples of FIGS. 1-4, wherein like numbers indicate the same or corresponding elements throughout the views. These embodiments are shown and described only for purposes of illustrating examples of the elements of the invention, and should not be considered as limiting on alternative structures or assemblies that will be apparent to those of ordinary skill in the art.

An ATV in accordance with the teachings of the present invention can include, for example, any of a variety of off road vehicles configured for recreational and/or utility purposes and that comprise a handlebar assembly to facilitate steering of the ATV by an operator. For example, an ATV 10 is depicted in FIG. 1 as including four wheels, namely, a left front wheel 22, a left rear wheel 24, a right front wheel 26, and a right rear wheel 28. It should be appreciated, however, that other ATVs in accordance with the teachings of the present invention might alternatively include fewer or greater than four wheels. At least some of an ATV's wheels can be configured as drive wheels, whereby their rotation is caused by a drive system present upon the ATV, and their contact with the ground while rotating causes movement of the ATV.

The ATV 10 is also shown to include a handlebar assembly 12 to facilitate steering of the left front wheel 22 and the right front wheel 26 by an operator of the ATV 10. The handlebar assembly 12 can include a left handlebar 14 and a right handlebar 16. The left handlebar 14 can be provided with a left handgrip 18 and the right handlebar 16 can be provided with a right handgrip 20. An operator of the ATV 10 can, during operation of the ATV 10, selectively place his or her left hand on the left handgrip 18 and/or his or her right hand on the right handgrip 20. A seat 30 can be provided upon which an operator may rest during operation of the ATV 10.

An ATV in accordance with the present invention can include a drive system, as is generally depicted at location 32 in FIG. 1. Although the drive system will typically include an internal combustion engine to facilitate rotation of the ATV's drive wheels, it may alternatively include a battery powered electric motor to facilitate this rotation. In such circumstances where an internal combustion engine is provided, the internal combustion engine can be configured to consume gasoline, diesel fuel, kerosene, natural gas, propane, alcohol, and/or any of a variety of other fuels.

The drive system of an ATV can also include one or more power transmission devices to facilitate selective transmission of rotational power from the internal combustion engine or electric motor to one or more of the drive wheels. While the drive system may include a transmission and/or a manual or automatic clutch, whereby such components determine whether any of the drive wheels are rotated, the drive system can additionally include components which can be used to select which of the drive wheels is/are rotated. For example, the drive system can include a transfer case which selectively allows power to be transmitted from the internal combustion engine or electric motor to the front wheels of the ATV. As another example, the drive system can include one or more selectively locking differentials to control whether rotational slip may exist between multiple wheels (e.g., rear wheels 24, 28). An operator of the ATV can control which drive wheels are rotated through use of a drive wheel selection actuator which is connected with the transfer case, selectively locking differential, and/or other component of the ATV's drive system.

A drive wheel selection actuator in accordance with the teachings of the present invention can comprise any device which is configured to be contacted by an operator of an ATV which, in response to this contact, facilitates application or removal of driving power from one or more wheels of the ATV. In one particular embodiment of the present invention, the drive wheel selection actuator comprises a switch that is electrically connected with the drive system of an ATV and is configured as a four wheel drive activation switch. This four wheel drive activation switch can have at least a first position and a second position, and can be configured to selectively generate a two wheel drive command signal when in its first position and a four wheel drive command signal when in its second position.

The drive system can receive signals from a drive wheel selection actuator and can be configured for selective mechanical coupling with each of the drive wheels of the ATV. For example, upon receipt of a two wheel drive command signal from a four wheel drive activation switch, an ATV's drive system can be adapted to cause rotation of only the rear wheel(s) of the ATV. However, upon receipt of a four wheel drive command signal from the four wheel drive activation switch, the drive system can be configured to cause rotation of both the front wheel(s) and the rear wheel(s) of the ATV.

In one particular embodiment, a four wheel drive activation switch can be connected with an ATV's transfer case. When the four wheel drive activation switch is in its first position, the transfer case can disengage the front wheels of the ATV so that only the rear wheels are driven. When the four wheel drive activation switch is in its second position, the transfer case can engage the front wheels so that both the front and rear wheels are driven.

In other embodiments, a drive wheel selection actuator can be configured not as a four wheel drive activation switch, but alternatively as a differential locking switch for controlling a front and/or rear differential lock of the ATV. A drive wheel selection actuator could alternatively be configured for use upon ATVs having fewer or greater than four wheels. Additionally, although a drive wheel selection actuator could comprise one or more switches such as a toggle switch, rocker switch, slide switch, pull-type switch or knife switch, it could alternatively be provided as a rotatable knob, lever, latching or non-latching pushbutton, or in some other configuration or combination thereof. Furthermore, although a drive wheel selection actuator can be electrically connected (e.g., with one or more electrical wires) to one or more components of an ATV's drive system, this connection could alternatively be accomplished mechanically such as through use of a movable wire linkage.

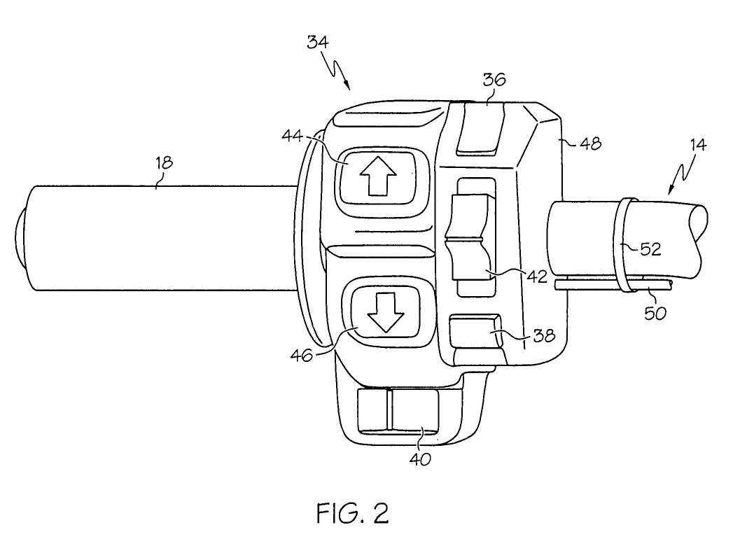

In accordance with one embodiment of the present invention, a drive wheel selection actuator can be attached to a handlebar of an ATV at a location adjacent to either of the left or right handgrip. In one particular embodiment of the present invention, as shown for example in FIGS. 1-2, a drive wheel selection actuator can comprise a four wheel drive activation switch 36 which is provided in a control panel 34 attached to the left handlebar 14 adjacent to the left handgrip 18. The control panel 34 includes a housing 48 which can additionally include one or more other control devices for the ATV 10. These other control devices can include, for example, an engine control, such as an engine start pushbutton 38 and/or an engine stop switch 40. These other control devices might additionally or alternatively include one or more lamp controls (e.g. 42) configured to selectively activate at least one of a running light, a headlight, and a turn signal. The other control devices disposed within the housing 48 might additionally or alternatively include a gear shifting control. In one embodiment, the gear shifting control can include an upshift pushbutton 44 and a downshift pushbutton 46. A cable 50 can extend from the control panel 34, down the left handlebar 14, and to the controlled components of the ATV 10. One or more straps (e.g. 52) can be provided to secure the cable 50 with respect to the left handlebar 14.

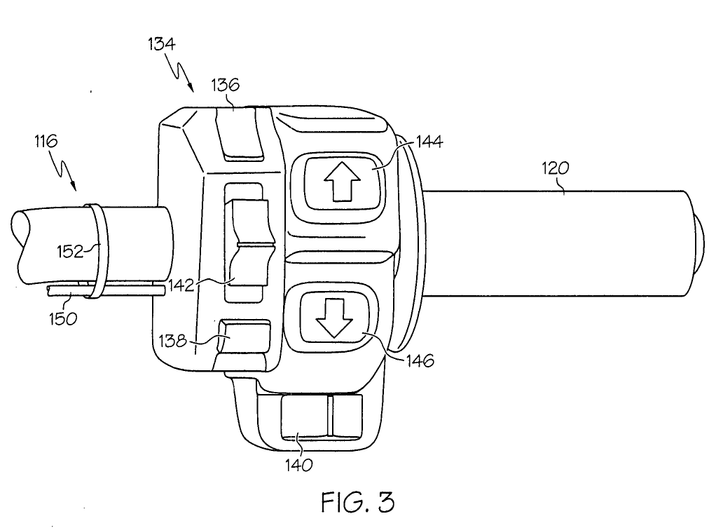

It will be appreciated that a control panel in accordance with the present invention might be provided in any of a variety of alternative locations or configurations upon a handlebar of an ATV. For example, as depicted in FIG. 3, a control panel 134 can be attached to the right handlebar 116 of an ATV adjacent to a right handgrip 120. This control panel 134 can include a housing 148 in which a four wheel drive activation switch 136, an engine start pushbutton 138, and engine stop switch 140, a lamp control switch 142, an upshift pushbutton 144, and a downshift pushbutton 146 are disposed. A cable 150 can extend from the control panel 134, down the right handlebar 116, and to controlled devices on an ATV. One or more straps (e.g. 152) can be provided to secure the cable 150 with respect to the right handlebar 116.

Although the control panels depicted in FIGS. 2-3 are shown to include many other control devices along with a drive wheel selection actuator (i.e., four wheel drive activation switch 36, 136), it should be appreciated that a control panel in accordance with the teachings of the present invention might include a drive wheel selection actuator along with as few as only one additional control component for the ATV. For example, when an ATV is not provided with electronic gear shifting and/or lights, a control panel in accordance with the teachings of the present invention might simply include a four wheel drive activation switch and an engine start/stop switch. As another example, if an ATV does not have electronic gear shifting capability and its engine controls are provided on a center console or near the ATV's engine, a control panel in accordance with the teachings of the present invention might include only a four wheel drive activation switch and a lamp control (e.g., for the headlight).

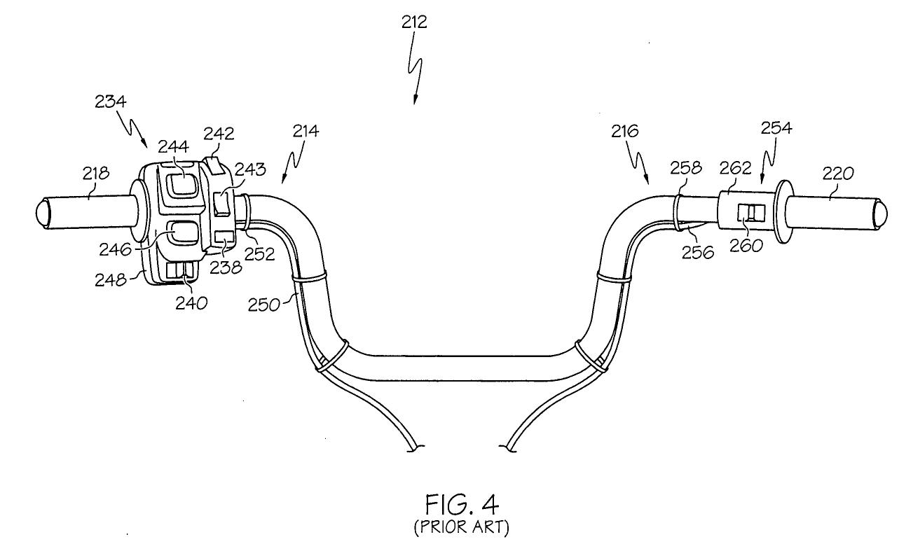

FIG. 4 depicts a conventional arrangement in which a handlebar assembly 212 for an ATV includes a left handlebar 214 having a left handgrip 218 and a right handlebar 216 having a right handgrip 220. A first control panel 234 is connected to the left handlebar 214 adjacent to the left handgrip 218, and a second control panel 254 is connected to the right handlebar 216 adjacent to the right handgrip 220. The first control panel 234 includes a housing 248 in which an engine start button 238, an engine stop switch 240, lamp controls 242, 243, an upshift pushbutton 244, and a downshift pushbutton 246 are all mounted. A cable 250 extends from the first control panel 234 and down the left handlebar 214, and is attached to the left handlebar 214 with straps (e.g. 252). The second control panel 254 includes a housing 260 in which a four wheel drive activation switch 260 is disposed. A cable 256 extends from the housing 262 and down the right handlebar 216, and straps (e.g. 258) attach the cable 256 to the right handlebar 216. In this configuration, multiple housings (248, 262), multiple cables (250, 256), and extra straps (e.g. 252, 258) are required as compared to a control panel in accordance with the present invention in which a drive wheel selection actuator is incorporated within a common housing with one or more other control devices for the ATV, as described above with respect to FIGS. 1-3, for example.

Significant benefits can be achieved by placing a drive wheel selection actuator within the same housing as the other handlebar mounted ATV control devices. For example, any cables extending from the drive wheel selection actuator can be bundled with any cables leading from the other control devices, and can, for example, even be disposed within a common outer wire sheath or insulation as shown, for example, in FIG. 2. Hence, in such a configuration, presence of the drive wheel selection actuator upon a handlebar of an ATV does not require the presence of an additional unsightly cable and/or clamps. Additionally, by placing the drive wheel selection actuator within the same housing as the other ATV control devices, a need for multiple housings for control devices can be avoided, and clutter upon the handlebar can resultantly be avoided.

The foregoing description of embodiments and examples of the invention has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate the principles of the invention and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. An all terrain vehicle comprising:
at least one front wheel;
a plurality of rear wheels;
a drive system;
a handlebar assembly; and
a control panel attached to the handlebar assembly supporting a plurality of control devices, one of the control devices comprising a drive wheel selection actuator-connected with the drive system and configured to facilitate selective mechanical coupling of the drive system with at least one of the wheels, and at least one other of the control devices comprising a control device other than a drive wheel selection actuator.

2. The all terrain vehicle of claim 1 wherein the handlebar assembly comprises a left handlebar and a right handlebar.

3. The all terrain vehicle of claim 2 wherein the left handlebar includes a left handgrip and the control panel is attached to the left handlebar adjacent to the left handgrip.

4. The all terrain vehicle of claim 2 wherein the right handlebar includes a right handgrip and the control panel is attached to the right handlebar adjacent to the right handgrip.

5. The all terrain vehicle of claim 1 wherein the drive wheel selection actuator comprises a four wheel drive activation switch.

6. The all terrain vehicle of claim 1 wherein the drive wheel selection actuator is electrically connected with the drive system.

7. The all terrain vehicle of claim 1 wherein the at least one other of the control devices supported by the control panel comprises an engine control.

8. The all terrain vehicle of claim 7 wherein the engine control comprises at least one of an engine start pushbutton and an engine stop switch.

9. The all terrain vehicle of claim 7 wherein the at least one other of the control devices supported by the control panel comprises a lamp control configured to selectively activate at least one of a running light, a headlight, and a turn signal.

10. The all terrain vehicle of claim 9 wherein the at least one other of the control devices supported by the control panel comprises a gear shifting control including an upshift pushbutton and a downshift pushbutton.

11. The all terrain vehicle of claim 7 wherein the at least one other of the control devices supported by the control panel comprises a gear shifting control including an upshift pushbutton and a downshift pushbutton.

12. The all terrain vehicle of claim 1 wherein the at least one other of the control devices supported by the control panel comprises a gear shifting control including an upshift pushbutton and a downshift pushbutton.

13. The all terrain vehicle of claim 12 wherein the at least one other of the control devices supported by the control panel comprises a lamp control configured to selectively activate at least one of a running light, a headlight, and a turn signal.

14. The all terrain vehicle of claim 1 wherein the at least one other of the control devices supported by the control panel comprises a lamp control configured to selectively activate at least one of a running light, a headlight, and a turn signal.

15. An all terrain vehicle comprising:
a left front wheel, a right front wheel, a left rear wheel, and a right rear wheel;
a drive system configured for selective mechanical coupling with each of the left front wheel, the right front wheel, the left rear wheel, and the right rear wheel, the drive system being adapted to cause rotation of only at least one of the left rear wheel and the right rear wheel upon receipt of a two wheel drive command signal, and to cause rotation of at least one of the left front wheel and the right front wheel, and at least one of the left rear wheel and the right rear wheel, upon receipt of a four wheel drive command signal;
a handlebar assembly including a left handlebar and a right handlebar, the left handlebar having a left handgrip and the right handlebar having a right handgrip;
a control panel attached to one of the left handlebar and the right handlebar adjacent to one of the left handgrip and the right handgrip, the control panel supporting:
a drive wheel selection actuator connected with the drive system and configured to selectively generate the two wheel drive command signal and the four wheel drive command signal;
an engine control comprising at least one of an engine start pushbutton and an engine stop switch; and
a lamp control configured to selectively activate at least one of a running light, a headlight, and a turn signal.

16. The all terrain vehicle of claim 16 wherein the control panel further supports a gear shifting control including an upshift pushbutton and a downshift pushbutton.

17. The all terrain vehicle of claim 15 wherein the drive wheel selection actuator comprises a switch that is electrically connected with the drive system.

18. A control panel configured for attachment to a handlebar of an all terrain vehicle adjacent to one of a left handgrip and a right handgrip, the control panel comprising:
a drive wheel selection actuator;
an engine control comprising at least one of an engine start pushbutton and an engine stop switch; and
a lamp control configured to selectively activate at least one of a running light, a headlight, and a turn signal.

19. The control panel of claim 18 further comprising an upshift pushbutton and a downshift pushbutton.

20. The all terrain vehicle of claim 18 wherein the drive wheel selection actuator comprises a four wheel drive activation switch.
